(19) United States
(12) Patent Application Publication
(10) Pub. No.: US 2025/0140457 A1
(43) Pub. Date: May 1, 2025

(54) FERROMAGNETIC POLYMERS AND MAGNETIC FIELDS IN SOFT MAGNETIC COMPOSITES

(71) Applicant: XEROX CORPORATION, Norwalk, CT (US)

(72) Inventors: Daniel Bullard, Conroe, TX (US); Ravi Neelakantan, San Francisco (CA)

(21) Appl. No.: 18/497,570

(22) Filed: Oct. 30, 2023

(51) Int. Cl. H01F 1/20; H01F 41/00; H02K 1/02; H02K 15/02

(52) U.S. Cl. CPC H01F 1/20; H01F 41/00; H02K 1/02; H02K 15/02; B22F 2202/05; B22F 2998/10

(57) ABSTRACT

A shaped structure having a fixed ferromagnetic polymer material aligned to a unified alignment direction. The shaped structure may include ferromagnetic particles suspended in the fixed ferromagnetic polymer material, and the ferromagnetic particles are aligned to the unified alignment direction. A method of manufacturing a structure includes forming ferromagnetic polymer precursors, dispensing the ferromagnetic precursors into a shaped structure, applying a magnetic field to cause the ferromagnetic precursors to align to a unified crystallographic orientation, and finishing the shaped structure to form a ferromagnetic polymer with a fixed unified crystallographic orientation and produce the structure.

### TECHNICAL FIELD

This disclosure relates to soft magnetic composites, more particularly to soft magnetic composites using ferromagnetic polymers and their use in motors.

### BACKGROUND

Ferromagnetic materials have several uses, including transformers and motors. Ferromagnetic materials are generally divided into three classes of materials that include soft magnetic composites, soft magnetic alloys, also known as electrical steels, and soft magnetic oxides. On the positive side, soft magnetic alloys generally have high saturation magnetization, but on the negative side, they have high eddy current losses. Soft magnetic oxides typically achieve medium magnetization with low eddy current losses. Soft magnetic composites have similar performance characteristics as the oxides.

Soft magnetic composites (SMCs) are a class of materials in which polymer binders have ferromagnetic powders suspended within them. The polymers bind the powder and make the composite rigid. These polymers reduce the permeability of the composite because they do not interact with applied magnetic fields in finished products, resulting in a lower magnetization compared to metals.

### SUMMARY

According to aspects illustrated here, there is provided a shaped structure having a fixed ferromagnetic polymer material aligned to a unified alignment direction.

According to aspects illustrated here, there is provided a method of manufacturing a structure includes forming ferromagnetic polymer precursors, dispensing the ferromagnetic precursors into a shaped structure, applying a magnetic field to cause the ferromagnetic precursors to align to a unified crystallographic orientation, and finishing the shaped structure to form a ferromagnetic polymer with a fixed unified crystallographic orientation and produce the structure.

### BRIEF DESCRIPTION OF THE DRAWINGS

FIG. 1 shows an embodiment of a soft magnetic composite with aligned ferromagnetic powders.

FIG. 2 shows an embodiment of a soft magnetic composite with aligned ferromagnetic polymers and powders.

FIG. 3 shows a method of manufacturing a soft magnetic composite with ferromagnetic polymers and powders.

FIG. 4 shows an apparatus for dispensing and aligning soft magnetic composites with ferromagnetic polymers.

### DETAILED DESCRIPTION OF THE EMBODIMENTS

Issues with current soft magnetic composites (SMCs) include low flux density and low permeability. Flux density represents the changes in energy flow across or through a surface. Permeability measures the magnetization that a material obtains in response to an applied magnetic field. One should note that the term “soft” as used herein is a term of art rather than a comparative term between “hard” and “soft.” The “soft” here refers to the class of materials of soft magnetic composites, or soft magnetic materials. The term “soft magnetic composite” as used here includes materials whether they include ferromagnetic polymers, or ferromagnetic polymers and metals.

Currently available SMCs typically consist of ferromagnetic powders suspended in a polymer binder. The polymer binder reduces the permeability of the overall composite. Conventional polymers typically have a permeability near 1. Ferromagnetic polymers have permeabilities approaching 300. While generally the embodiments will involve ferromagnetic powders suspended in a ferromagnetic polymer, it is possible that ferromagnetic polymers alone will suffice. The term “ferromagnetic polymer material” as used here includes both ferromagnetic polymers with ferromagnetic particles, and ferromagnetic polymers alone.

The embodiments involve applying a magnetic field to the SMC to cause the ferromagnetic polymer material to align into a unified alignment direction. A unified alignment direction means a single direction or orientation of a magnetic field to which a majority of the ferromagnetic polymers and/or the ferromagnetic powders align. Ideally, they would all completely align in the same direction. However, some may not align in exactly the same direction, with some having some variation from the unified direction. For purposes of this discussion, the polymers and/or particles aligning in a unified alignment direction does not necessary mean they are all aligned to the exact same direction. Some variation is included.

For ferromagnetic powders, this would comprise a unified crystallographic orientation in which the same crystal plans of the powder particles would all face the same direction. Some embodiments do not have powders with crystals, so the more general term is used. Ferromagnetic polymer chains would align in the same direction as the crystals.

This provides higher flux density of the material. The ferromagnetic polymer can then lock the orientation into place when it undergoes polymerization. This may also be referred to as curing or solidifying. The term “fixed” or “becoming fixed” encompasses all these terms.

Motors and generators serve as examples of machines that use magnetic cores. Currently, these cores typically consist of laminations stamped from thin sheets of steel. The laminations are electrically insulated and stacked to make core components of motors and generators, such as rotors and stators. After assembly, the core parts undergo machining to remove stamping burrs. During the production of the steel used in the laminations, thermo-mechanical processing develops a preferred crystallographic orientation, or texture. In current processes, steel mills can only achieve between 30 and 70 percent by volume of the preferred orientation.

The embodiments here replace the steel laminations with ferromagnetic polymer material solidified into the desired shape, such as that of the laminations above. This increases the alignment of the powders into the crystallographic orientation to as high as 100% alignment. Instead of stamping parts out of steel, with a preferred crystallographic alignment of between 30 and 70%, the parts could result from extrusion, die casting, or printing. Application of the magnetic field occurs either while the parts are being extruded, printed, or die cast, or immediately afterwards to lock in the aligned orientation of the ferromagnetic polymer material. The resulting parts would have better flux density because of the unified orientation, and better permeability because of the use of the ferromagnetic polymer as a binder in embodiments with the ferromagnetic powder.

Another advantage of using the powders beyond just increasing the magnetic properties lies in the ability control composition. The process can control the concentration of the powders within the binder as the material forms the parts, allowing for an extra level of uniformity of powders within the material, or even a non-uniformity of powders if the application calls for it.

FIG. 1 shows a graphical representation of ferromagnetic polymer material 10 having ferromagnetic powders in a binder according to currently available materials. The structure in FIG. 1 shows an example of a prior art ferromagnetic material 10. The material comprises a binder polymer 12 and ferromagnetic powder particles such as 14. The ferromagnetic particles may comprise one or more of iron, iron silicide, and iron silicon aluminum.

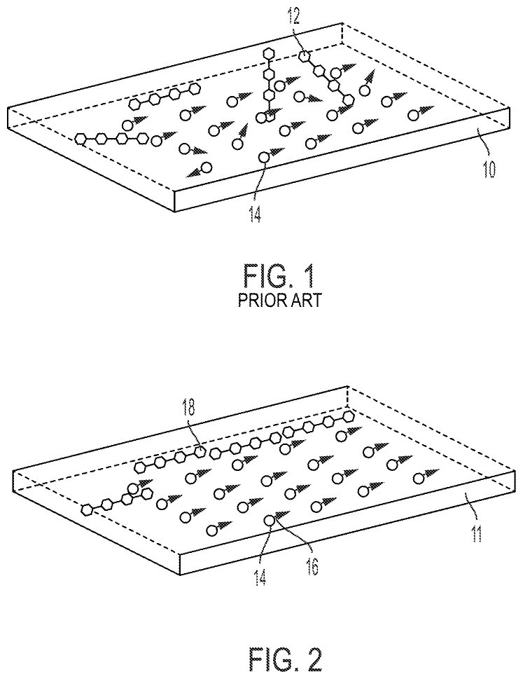

In FIG. 2, the ferromagnetic material 11 comprises a ferromagnetic polymer binder having the ferromagnetic powder particles such as 14. Upon application of a magnetic field, prior to the ferromagnetic polymer solidifying or curing, both the polymer chains of the ferromagnetic polymer 18 align to the same crystallographic alignment 16 as the particles such as 14. The ferromagnetic polymers not only align with the particles, but it also increases the permeability of the material allowing it to respond more completely to the magnetic field.

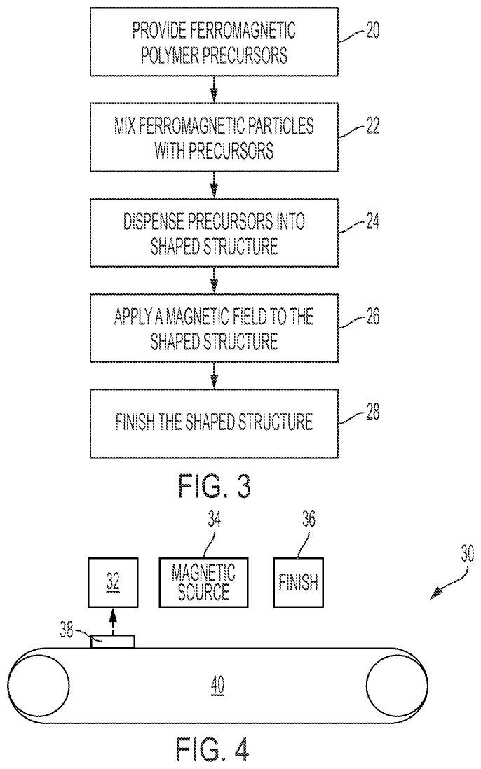

FIG. 3 shows a flowchart of an embodiment of a method to manufacture soft magnetic composite structures using ferromagnetic materials. These structures may comprise core parts such as those discussed above. The process may begin with providing the ferromagnetic polymer precursors at 20. For purposes of the discussion herein, “providing” ferromagnetic polymer components may comprise acquiring previously existing polymerizable materials in solution or mixing the solution. These component materials may comprise many different combinations, examples of which are discussed below. The polymerization reactions may take the form of either components undergoing polymerization together, or one component being grafted onto another component. The term “precursor” as used here in includes monomers and polymers, as some of the materials used may include polymers, such as polymers in solution, and monomers that are then polymerized. No limitation to one or the other is intended nor should it be implied. The mixture of precursors forms the soft magnetic material, where the term “soft” only refers to it not being fixed.

The presence of unpaired electrons in monomer units of a polymer chain induces ferromagnetism in that it responds to a magnetic field. There are several ways of including ferromagnetic monomers into a polymer chain. One embodiment uses 2,2,6,6-tetramethylpiperidin-1-oxyl (known as TEMPO). TEMPO contains a nitroxide group, which has an unpaired electron and gives rise to the ferromagnetic property of the monomer unit. A polymerizable version of TEMPO, TEMPO-methacrylate, is shown below:

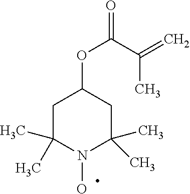

TEMPO-methacrylate can polymerize via radical polymerization to create linear chains of TEMPO-methacrylate with high molecular weights, and a radical-to-monomer ratio of close to 1. To fabricate monolithic structures, TEMPO-methacrylate, or analogous ferromagnetic monomers which can be polymerized via radical polymerization, can be co-polymerized with bi-, tri-, tetra-, penta-functional, or greater if they exist, crosslinking monomer units. Some examples of cross-linking units are divinylbenzene, ortho, meta or para, SR399 a commercial resin, shown below:

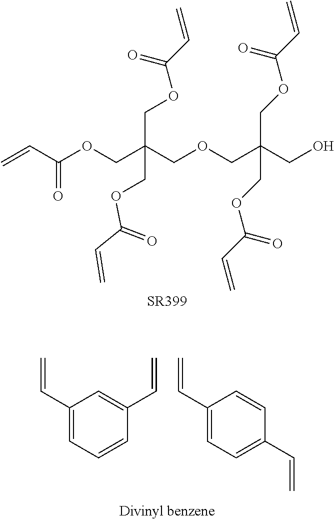

Another embodiment forms a ferromagnetic polymer using radical polymerization with epoxide cross-linking. In some examples in literature, TEMPO-methacrylate is co-polymerized with an acrylic monomer with a pendant epoxy group which can be used to cross-link adjacent chains.

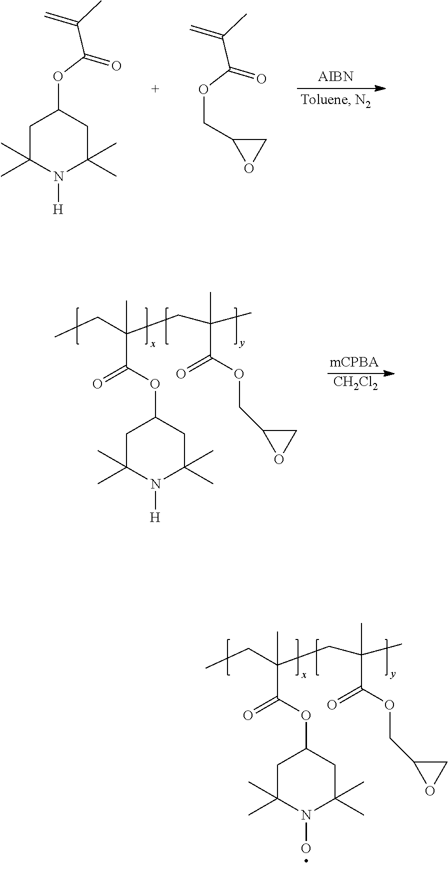

In addition to radical polymerizations, poly(TEMPO-methacrylate) (PTMA) can be synthesized via anionic polymerization, shown above. In this type of polymerization, cross-linking (formation of monolithic structures) can be achieved via the inclusion of multi-functional cross-linking molecules which engage in anionic polymerizations. This could include multi-functional methacrylates, or epoxies.

Another method of fabricating ferromagnetic polymers is to graft ferromagnetic molecules to the polymer chain. Some examples of functionalized TEMPO molecules are shown below.

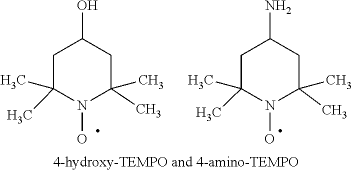

Hydroxy and amino TEMPO derivatives offer a nucleophile which can be used to graft the molecule to polymer chains. For example, these derivatives could be added to poly(acrylic acid)-derived polymers via hydrolysis of the carboxylic acid to form an ester or amide linkage to TEMPO.

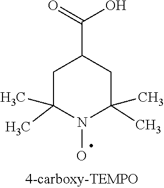

Alternatively, 4-carboxy-TEMPO can be grafted to polymer backbones containing amine or hydroxyl groups via the same mechanism to form ester or amide linkages to the polymer backbone. For example, poly(vinyl alcohol)- or poly(vinyl amine)-derived polymers would meet the criteria. The various groups mentioned above may comprise functional groups attached to the monomers that cross-link to other functional groups upon polymerization.

As shown in FIG. 3, the precursor materials for the ferromagnetic polymer are provided at 20. This may include TEMPO-methacrylate and divinylbenzene, 4-carboxy-TEMPO and polymer backbones from the examples above, or other materials having similar characteristics. The ferromagnetic powder particles are mixed with the precursors at 22, but as mentioned above, this step may be optional.

As will be discussed in more detail below at a compaction process that may occur during the finishing of the material, one goal is to form the material with the ferromagnetic particles as close together as possible. The ferromagnetic polymers would then fill the gaps. This may result in a need to have an excess of the ferromagnetic material, removable during the finishing step.

In embodiments that employ ferromagnetic particles, options exist that would increase their density with the same goal above. These include functionalizing the ferromagnetic particles with some sort of surface modification of a material that has a group that can bond with the ferromagnetic or polymers and another group to bond with the ferromagnetic particles. This may include using coupling agents mixed with the ferromagnetic particles at 22.

Another option involves the grafting discussed above. Another option includes using compatibilizers, such as block copolymers having segments compatible with the ferromagnetic particles and segments compatible with the polymers. Other options include surfactants that reduce the surface tension between the ferromagnetic particles and the particles, plasticizers that reduce the viscosity of the polymers, and controlling the particle size and distribution. These materials may be included in the precursors during the formation process.

The ferromagnetic polymer precursors at this point may comprise a solution or a gel, depending upon the component materials, and forms the soft magnetic material. It is “soft” in that it has not yet hardened, such as by a polymerization reaction, which may include cross-linking. The polymerization reaction will typically be conducted under a magnetic field to induce alignment of the ferromagnetic polymers with or without the particles. The soft magnetic material has a viscosity that allows it to be dispensed onto a formation surface at 24. The dispensing may involve printing, extrusion, or die casting, depending upon its viscosity. The formation surface may comprise a flat surface, a mold, etc. Once dispensed, the material forms a shaped structure, either printed or extruded, molded, as examples. The process then applies a magnetic field at 24, either during the dispensing process or immediately after, but before the shape sets, however the setting occurs.

Application of the magnetic field causes the ferromagnetic polymer precursors, and the particles if used, to assume a unified crystallographic orientation, meaning they are all aligned in one direction. Once dispensed and aligned, the shaped structure may undergo finishing at 26. If the polymerization reaction, with or without cross-linking, results from chemical agents, rather than external energy sources such as UV or heat, the finishing may comprise a timer to allow the polymerization reaction to complete. If the polymerization reaction uses photopolymerization or thermal reactions, the finishing may involve application of that energy to cause the polymerization and then cooling. These would be applied in conjunction with the magnetic field. The finishing may also involve compaction, mentioned above, in which the polymer/particle structure undergoes a compression process that pushes the particles closer together, and may “squeeze out” any excess ferromagnetic polymers. This may need to be done prior to setting the polymer completely.

The type of manufacturing apparatus may take many forms. FIG. 4 shows one embodiment of such an apparatus 30. In this embodiment, the manufacturing surface 40 may comprise a moving belt or other movable surface, such as a movable stage. The surface that receives the ferromagnetic precursors may reside on the belt or stage or could be the belt or stage itself.

The material may travel past the various stations or may just involve moving the mechanisms past the shaped structure 38. The dispensing system 32, as discussed above, may comprise a reservoir of the ferromagnetic precursors, and print head, a die cast fixture, or an extrusion head. Once the shaped structure is formed by the material being dispensed onto the formation surface, such as into a shaped structure, a magnetic source applies a magnetic field to the shaped structure 38. The ferromagnetic polymers and the ferromagnetic powder particles, if used, align along the magnetic field lines in a unified crystallographic orientation. During, or possibly after, the alignment process, the shaped structure undergoes finishing with the finishing source 36. The finishing source and the magnetic source may be co-located as dictated by the material used to form the ferromagnetic material.

In this manner, a ferromagnetic structure is formed that can be used as stators, rotors, etc. The structure may comprise a stack of thinner components like the stamped steel laminations that are then formed into a stator core, motor core, or a transformer core, or it may be one solid component that forms the entirety of the core. The resulting structure does not require an unwieldy stamping process to form the intricate shapes needed. They weigh less, with better flux density and permeability, increasing their power and efficiency.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A shaped structure comprising a fixed ferromagnetic polymer material aligned to a unified alignment direction.

2. The shaped structure as claimed in claim 1, further comprising ferromagnetic particles suspended in the fixed ferromagnetic polymer material, and the ferromagnetic particles are aligned to the unified alignment direction.

3. The shaped structure as claimed in claim 2, wherein the ferromagnetic particles comprise at least one of iron, iron silicide, and iron silicon aluminum.

4. The shaped structure as claimed in claim 1, wherein the shaped structure comprises at least part of a core of one of a stator, a rotor, motor, or transformer.

5. A method of manufacturing a structure, comprising:
forming ferromagnetic polymer precursors;
dispensing the ferromagnetic precursors into a shaped structure;
applying a magnetic field to cause the ferromagnetic precursors to align to a unified crystallographic orientation; and
finishing the shaped structure to form a ferromagnetic polymer with a fixed unified crystallographic orientation and produce the structure.

6. The method of manufacturing as claimed in claim 5, wherein finishing the shaped structure comprises polymerizing the ferromagnetic polymer precursors.

7. The method of manufacturing as claimed in claim 6, wherein polymerizing the ferromagnetic polymer precursor comprises polymerizing a precursor having ferromagnetic functional monomer groups.

8. The method of manufacturing as claimed in claim 7, wherein polymerizing the ferromagnetic functional monomer groups comprises one of radical polymerization, radical polymerization with epoxide cross-linking, and anionic polymerization.

9. The method of manufacturing as claimed in claim 7, wherein polymerizing ferromagnetic functional monomer groups comprises polymerizing TEMPO-methacrylate with one or divinylbenzene or an acrylic monomer with a pendant epoxy group.

10. The method of manufacturing as claimed in claim 6, wherein forming the ferromagnetic polymer precursors comprises combining a ferromagnetic molecule with a material having a polymer backbone.

11. The method of manufacturing as claimed in claim 10, wherein grafting a ferromagnetic molecule to one or more polymer chains comprises one of adding one of 4-hydroxy-TEMPO or 4-amino-TEMPO to poly(acrylic acid)-derived polymers.

12. The method of manufacturing as claimed in claim 10, wherein grafting a ferromagnetic molecule to one or more polymer chains comprises adding 4-carboxy-TEMPO to one of poly(vinyl alcohol)-derived or poly)vinyl amine)-derived polymers.

13. The method of manufacturing as claimed in claim 5, wherein dispensing the ferromagnetic precursors soft magnetic material into a shaped structure comprises one of printing, extruding, and die casting.

14. The method of manufacturing as claimed in claim 5, wherein forming a soft magnetic material from a ferromagnetic polymer comprises mixing ferromagnetic powder particles into a precursor of the ferromagnetic polymer.

15. The method of manufacturing as claimed in claim 14, further comprising at least one of functionalizing the ferromagnetic powder particles, adding one or more of compatibilizers, surfactants, plasticizers, and controlling the particle size and distribution.

16. The method of manufacturing as claimed in claim 5, further comprising compressing the shaped structure to move the ferromagnetic particles closer together.

17. An apparatus for forming a ferromagnetic structure, comprising:
a reservoir to hold a soft magnetic material;
a dispenser configured to dispense the mixture into a shaped structure;
a magnetic source configured to apply a magnetic field to the shaped structure; and
a finishing station configured to harden the shaped structure to produce the ferromagnetic structure.

18. The apparatus of claim 17, wherein the dispenser comprises one of a print head, an extruder, and a die casting machine.

19. The apparatus of claim 17, wherein the finishing station comprises one of a heater, a cooler, a drier, a platform, and a curing station.

20. The apparatus of claim 17, wherein the finishing station and the magnetic source are co-located to align the soft magnetic material as the soft magnetic material becomes fixed.
